(19) United States
(12) Patent Application Publication
(10) Pub. No.: US 2008/0037661 A1
(43) Pub. Date: Feb. 14, 2008

(54) Mobile communication system having multiple modulation zones

(75) Inventor: Shao Xun, Seattle, WA (US)

Correspondence Address: FULBRIGHT & JAWORSKI L.L.P, 2200 ROSS AVENUE, SUITE 2800, DALLAS, TX, 75201-2784, US

(73) Assignee: Adaptix, Inc., Seattle, WA (US)

(21) Appl. No.: 11/501,221

(22) Filed: Aug. 8, 2006

(51) Int. Cl. H04L 27/00

(52) U.S. Cl. 375/259

(57) ABSTRACT

By arranging the area covered by a central transmission point into zones and by using different modulation schemes within each zone, increased throughput can be achieved by reducing the interference between communicating devices. The zones typically would be arranged by either distance from the transmission point or by passloss (PL), which is a measure of the signal attenuation of a wireless link. Either the wireless devices can determine the distance between them, or a point external to each device can make or assist with the determination. Multiple methods exist for determination or estimation of PL. In one embodiment, two zones are used with the zone closest to the transmission point, or having a lower PL, being 8 QAM or 16 QAM, while a zone further away, or having a higher PL, would be QPSK. Alternatively, the two zones could be SDMA and non-SDMA, respectively.

### TECHNICAL FIELD

This invention relates to mobile communication systems and more particularly to transmission schemes that minimize interference.

### BACKGROUND OF THE INVENTION

It is well known that in mobile communication systems that as traffic volume increases, the opportunity for signal interference between communication channels also increases. Over the years as these systems have evolved there have been a number of systems designed to deal with this problem. These systems usually revolve around separating frequency use (and reuse) into sectors. Some systems go further and divide each zone into channels or sub-channels. But at some point, when traffic density becomes high enough the trade-off becomes reduced clarity (high interference) or less capacity.

For example, systems use 16, 32, and 64 Quadrature Amplitude Modulation (QAM). In 16 QAM, four different phases and 4 different amplitudes are used for a total of 16 different symbols. 32 QAM delivers even higher data rates because it uses more amplitudes and phases. QAM is a modulation scheme which conveys data by changing (modulating) the amplitude of two carrier waves. These two waves, usually sinusoids, are out of phase with each other by 90° and are thus called quadrature carriers.

One problem with 16 QAM is that it requires high power and is thus prone to interfere with neighbors. A solution is to use another modulation scheme, such as Quadrature Phase Shift Keying (QPSK). QPSK is a digital frequency modulation technique used for sending data over coaxial cable networks. Since it is both easy to implement and fairly resistant to noise, QPSK is used primarily for sending data from the cable subscriber upstream to the Internet. QPSK interferes with its neighbors less mainly because it uses less power. Unfortunately, QPSK often does not have the bandwidth of 16 QAM. Thus, there is a trade-off between intereference levels and bandwidth.

This same problem results with other modulation schemes in that there are tensions between schemes that allow high capacity but which result in interference problems. One such scheme is a space division multiple access (SDMA) scheme where channels can be simultaneosuly reused within a single cell. SDMA improves system capacity due to channel reuse, but the additional transmission power levels in a cell using SDMA will increase interference with neighbors.

Complicating this trade-off between capacity and interference is passloss (PL), which is a measure of the signal attenuation of a wireless link. Generally, the further a mobile user is from the serving base station of a cell, the greater the PL. This is not always the case, due to obstructions and multipath effects, but for a clear, unobstructed wireless link, the assumption generally holds. The interference problem is exacerbated by PL, because each wireless link requires a minimum signal-to-noise ratio (SNR). This ratio is affected by interference levels, which may be expressed using a carrier-to-interference ratio (CINR) value.

Following the assumption that PL increases with the distance between a mobile unit and a serving base station, it is aparent that in order to maintain a minimum required CINR, a distant user may often need a higher transmit power (P), than a mobile unit nearby the serving base station. Unfortunately, a mobile unit that is distant from the serving base station is often closer to a neighboring cell. An example of this would be a user on a mobile unit that is near the boundary between two cells. Due to the user's distance from the serving cell, the PL is typically fairly high, requiring a higher transmit power, P. But the higher P causes a user that is closer to a neighbor cell to transmit even more power into the neighboring cell, which then becomes interference in that neighboring cell.

Since the CINR required for 16 QAM is typically higher than the CINR required for QPSK communication, a distant mobile unit operating with 16 QAM will produce more interference than a distant user operating with QPSK. SDMA provides a similar problem. If two users on the same channel or subchannel are near a cell boundary, with a relatively high PL, then two mobile units are simultaneously producing interference for a neighboring cell at a relatively high P.

### BRIEF SUMMARY OF THE INVENTION

By arranging the area covered by a central transmission point into zones and by using different modulation schemes within each zone, increased throughput can be achieved by reducing the interference between communicating devices. The zones typically would be arranged by either distance from the transmission point or by passloss (PL), which is a measure of the signal attenuation of a wireless link. Either the wireless devices can determine the distance between them, or a point external to each device can make or assist with the determination. Multiple methods exist for determination or estimation of PL. In one embodiment, two zones are used with the zone closest to the transmission point, or having a lower PL, being 8 QAM or 16 QAM, while a zone further away, or having a higher PL, would be QPSK. Alternatively, the two zones could be SDMA and non-SDMA, respectively.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, which:

FIG. 1 shows one embodiment of a communication system having zoned modulation schemes;

FIG. 2 shows one embodiment of flow control for determining the modulation scheme on a call by call basis;

FIGS. 3 and 4 show grid plans using the concepts of the invention; and

FIG. 5 shows embodiment of flow control for determining the modulation scheme on a call by call basis.

### DETAILED DESCRIPTION OF THE INVENTION

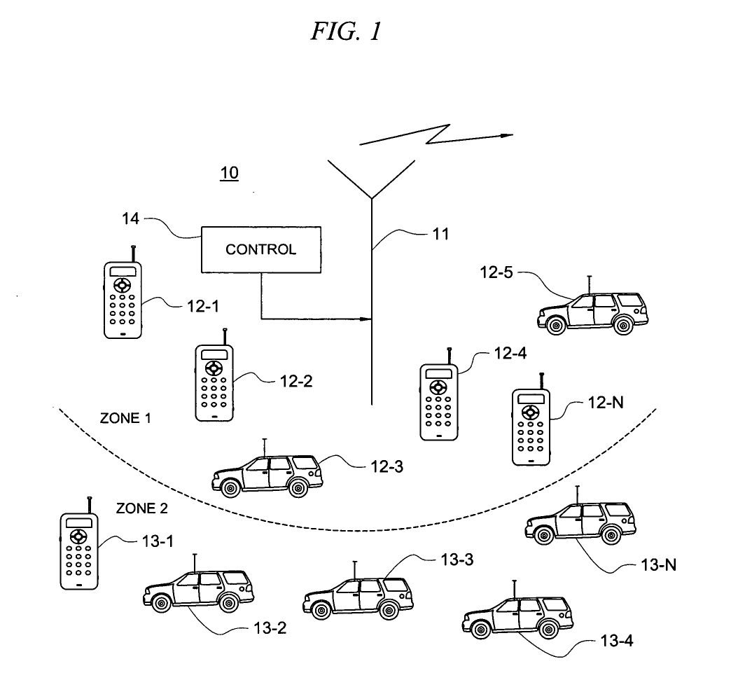

FIG. 1 shows one embodiment of communication system 10 having zoned modulation schemes. In the embodiment shown, transmission point 11 communicates wirelessly with any number of mobile communication devices, such as devices 12-1 to 12-N and devices 13-1 to 13-N. Note that while a single transmitter is shown, any number of transmitters can be used, some or all of which can cover the entire area served by the cell, or some or all of which can serve only portions of the cell. One or more of these transmitters can be controlled by control 14 which can be co-located with transmission point 11 or can be located at a remote location, or partially at each. In this context, the term transmission point means transmitting and/or receiving with both being either at the same physical location or at different locations but operating cooperatively.

System 10 is shown with multiple zones, such as inner zone 1 and outer zone 2, each of which has a different modulation scheme associated therewith. Although the zones are shown defined purely by radius, the zone boundaries 1 and zone 2 may be defined using either distances, passloss (PL), or a combination of both. As shown, mobile devices 12-1 through 12-N use one modulation scheme while devices 13-1 to 13-N use a different modulation scheme. Note that as many zones as are desired can be used with the zones designed to reduce interference of the transmissions between the mobile devices within that zone and the transmission point of a neighboring cell.

In the embodiment shown, two zones are used with the zone closest to the transmission point (zone 1) being a 16 QAM 10 zone while the zone further away (zone 2) is, for example, a QPSK zone. Alternatively, the two zones could be SDMA and non-SDMA. Further, a plurality of zones could be provided, with the innermost zone using both 16 QAM and SDMA, the outermost (or highest PL) zone using QPSK without SDMA, and intermediate zones using an acceptable combination of either 16 QAM or QPSK and SDMA or non-SDMA. As more modulation and frequency schemes become available for use, those schemes with higher capacity that produce more interference could be reserved for use in the inner-most zones, while those with lower interference potential could be used for outer-most zones.

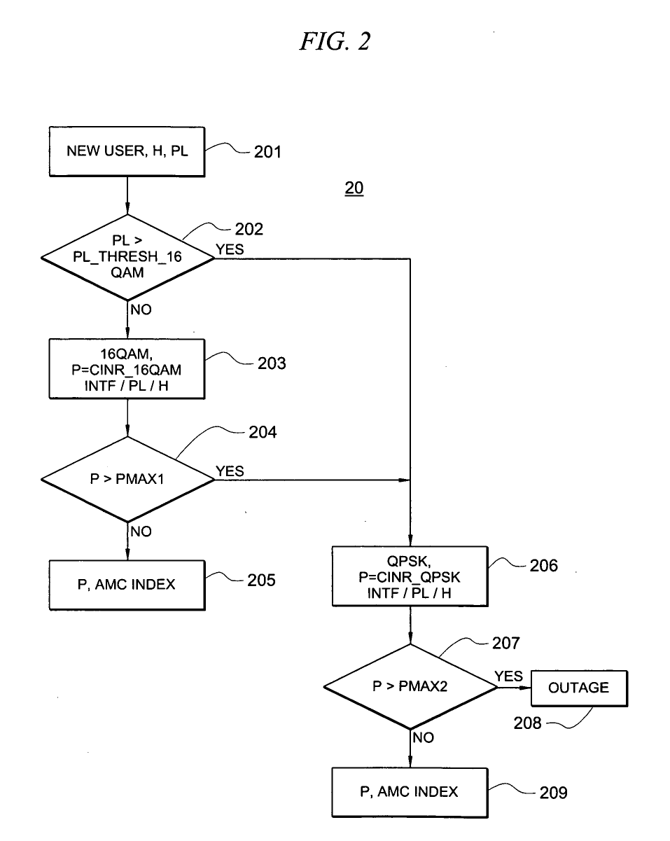

The determination of which modulation system a device will use can be determined in any number of ways. For example, FIG. 2 shows one embodiment 20 of flow control for determining the modulation scheme on a user-by-user basis. Process 201 determines that a new user with passloss, PL, has requested service on channel H. Process 202 then determines whether the PL of the potential new user is greater than the threshold allowable for the 16 QAM zone 1. If the threshold is exceeded, then the user would likely be producing too much interference for a neighboring cell, and 16 QAM is not available to that user. The user then moves to a QPSK scheme, beginning with process 206. If the PL does not exceed the threshold, process 203 determines the power, P, that is necessary to produce the required CINR for 16 QAM.

Process 204 then determines if the required P exceeds the maximum allowed transmission power PMAX1 for zone 1, the user. This second determination may be made only based on the new user's required P, or may be made using the transmission power of other users in the cell. Using information about other users could reduce the aggregate interference from one cell to another at times of heavy usage by a particular base station. Thus, zone 1 may be defined using dynamic criteria, including the number of other active users and the total radiated power.

If the PMAX1 level is exceeded, then 16 QAM is not available to that user, and the user moves to QPSK. This is similar to the result of process 202, described above. As shown in FIG. 2, zone 1 is defined by both PL and P passing two threshold tests. If either fails, the zone 1 boundary moves to exclude the new user, placing the new user in a lower-interference and lower-capacity zone. Note that some, or all, of the processes shown in embodiment 20 can be in the mobile device, for example as an algorithm contained in a memory, such as memory 1202, controlled by processor 1201 (FIG. 1) or in control 14 (FIG. 1).

If the user does satisfy the criteria for zone 1, then the user may use the higher-capacity communication scheme in process 206. The AMC index is stored. In this context the AMC index is a number that indicates which combination of modulation and coding scheme is chosen from all available combinations of modulation and coding schemes.

If either process 202 or process 204 excludes the new user from zone 1, then process 206 determines the power, P, that is necessary to produce the required CINR for QPSK. Process 207 determines if the newly set power level is greater than the PMAX2 for zone 2. As with the PMAX determination for zone 1, the PMAX2 level may be determined either individually, or based on the transmission power levels of other users. Further, the PMAX2 threshold may vary within a single cell, based on the density of users near different neighbors.

If the PMAX level is exceeded, then a connection is not made even in zone 2, as shown by outage process 208. However, if the required power is less than the allowed maximum power then process 213 controls the establishment of the air interface connection using QPSK modulation.

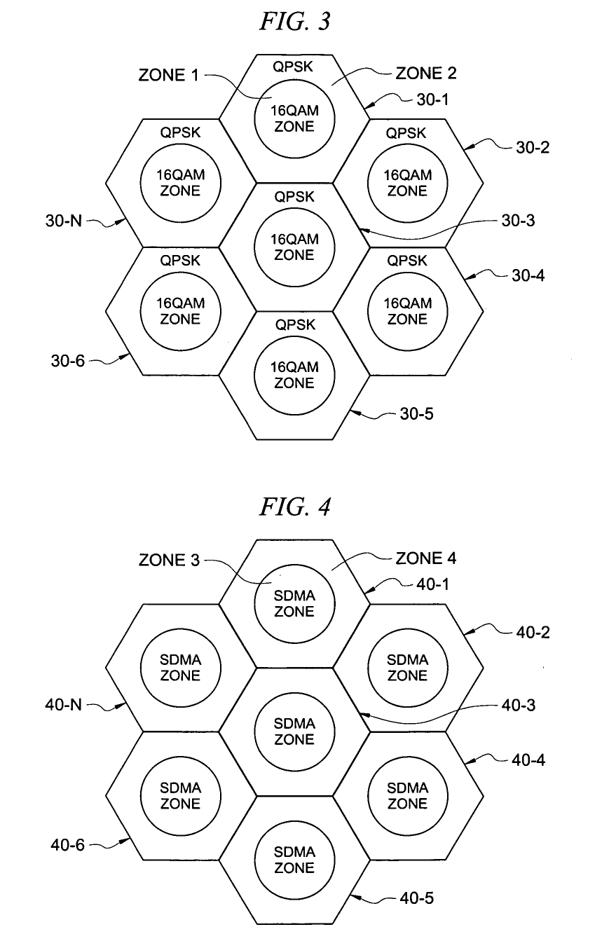

FIG. 3 shows on embodiment of a grid plan using the concepts of the invention such that the inner zone (zone 1) is a 16 QAM zone while the outer zone (zone 2) is a QPSK zone. The network is shown broken into cells, such as cells 30-1 through 30-N. While FIG. 3 shows the zones boundaries based purely on radius from the cell center, the zone boundaries may change dynamically, based on both an individual user's power needs, and the aggregate user load within a cell.

FIG. 4 shows one embodiment of a grid plan using the concepts of the invention such that the inner zone (zone 3) is a space division multiple access (SDMA) zone while the outer zone (zone 4) is a non-SDMA zone. The SDMA and non-SDMA zone boundaries are also dynamic and flexible, although a different decision method, discussed below, is used. The zone boundary determination between SDMA and non-SDMA may either be coupled with the zone boundary determination for 16 QAM and QPSK, such as through adjustment of the PMAX and thresholds, or the determinations may be entirely unrelated.

Due to the general tendencies of 16 QAM and SDMA to produce more interference than QPSK and non-SDMA, it is likely that zones 1 and 3 will have some degree of overlap. Further, it is likely that zones 2 and 4 will have some degree of overlap. However, there is also a possibility of overlap between zones 1 and 4, along with overlap between zones 2 and 3.

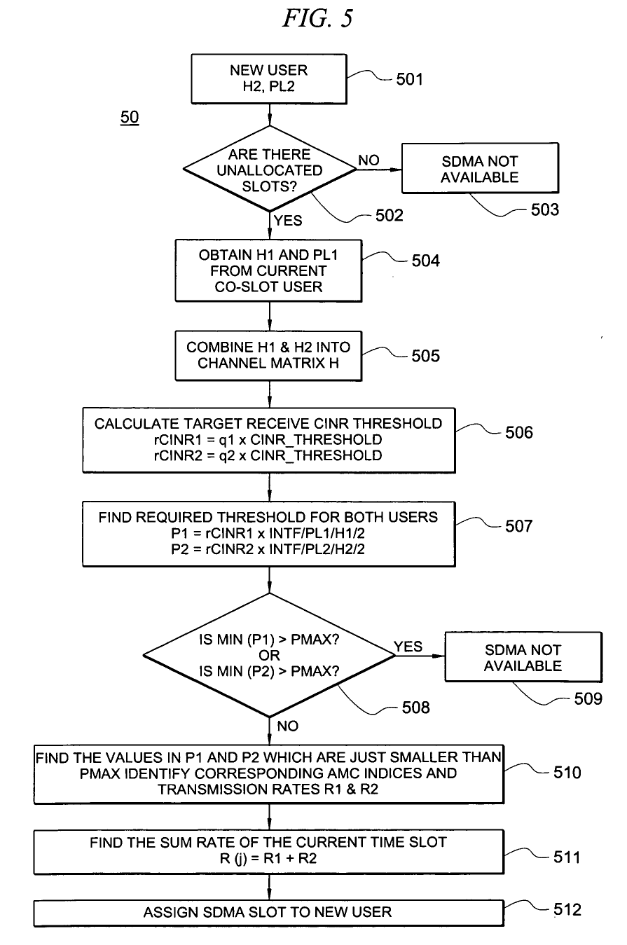

FIG. 5 shows one embodiment 50 of flow control for determining the use of SDMA on a user-by-user basis. Process 501 determines that a new user with passloss, PL2, has requested service on channel H2. Process 502 then determines whether there are any unallocated slots. If not, then the new user cannot use an SDMA slot, as shown by process 503. The user must then either use a non-SDMA channel, or will experience an outage.

If, however, there are available slots, then the PL1 and channel H1 from the current co-slot user is determined in process 504. The co-slot user is a prior-existing user that is currently using the same channel H, requested for reuse by the new user. The co-slot user will be in a different direction from the new user, in order for the SDMA scheme to allocate the same channel to both the new user and the co-slot user.

In process 505, H1 and H2 are combined into channel matrix H, to enable the calculation of CINR thresholds in process 506. Based on the CINRs required by each of the users, the transmit power levels of the two users, P1 and P2, are found in process 507. The P1 for the current co-slot user may be affected by the addition of new user, since the new user is requesting to use the same channel. Therefore, both the new user's required power, P2, and the current co-slot user's new power level, P1, are tested against the maximum allowable transmit power, PMAX, as shown in process 508. Although FIG. 5 shows both P1 and P2 tested against a single PMAX value, different PMAX values could be used, based on the users' locations in the cell. Further, the PMAX for SDMA determination may be different from the PMAX values used for 16 QAM and QPSK.

If either P1 or P2 exceeds PMAX, then SDMA is not available to the new user on the tested channel, as shown in process 509. The current co-slot user will not share the channel with the new user. Either a different SDMA channel must be tested, the user must use a non-SDMA channel, or the user will experience an outage.

If neither P1 or P2 exceeds PMAX, then SDMA is available to the new user on the tested channel. In optional process 510, P1 and P2 values are found that are just below PMAX, to enable identification of transmission rates R1 and R2. The total channel capacity may be found in optional process 511, and the SDMA slot is assigned to new user in process 512.

Although FIG. 5 shows the addition of a new user to a channel with only a single co-user, any number of prior existing co-users may exist, depending on the capacity of the SDMA system. With multiple co-slot users, processes 504 through 511 may be expanded to include channel information from all the co-slot users, calculate the power levels required by each, and test each for violation of PMAX.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of operating a communications system, said method comprising:
communicating from a transmission point to a plurality of stations positioned, at least temporarily, at certain distances from said transmission point; and
determining for each station from time to time which one of at least two distinct transmission modulation schemes is appropriate for transmissions between said station and said transmission point.

2. The method of claim 1 wherein said determining is based, at least in part, on the distance between said transmission point and said station.

3. The method of claim 2 wherein said distance is determined by a GPS determination of the position of said station.

4. The method of claim 3 wherein said GPS determination is made local to each station and communicated to a control point external to said station.

5. The method of claim 2 wherein said distance is determined by a control point external to said station.

6. The method of claim 1 wherein said determining is based, at least in part, by interference calculations on a station by station basis.

7. The method of claim 6 wherein said interference calculations are made, at least in part, at a central control point.

8. The method of claim 1 where in said determining is based, at least in part, by the passloss of a particular station.

9. The method of claim 1 wherein said modulation schemes are selected from the list of QPSK, 16 QAM, 64 QAM, SDMA, AMC.

10. The method of claim 1 wherein for stations positioned within a first boundary distance from said transmission point said modulation scheme is selected from the list of 8 QAM, 16 QAM, and SDMA and for stations positioned outside of said boundary said modulation scheme is a scheme other than either 8 QAM, 16 QAM or SDMA.

11. The method of claim 10 wherein when said modulation schemes is QPSK within said boundary it is either 16 or 64 QAM outside said boundary.

12. The method of claim 10 wherein when said modulation scheme is SDMA within said boundary it is non-SDMA outside said boundary.

13. The method of claim 1 further comprising:
changing said modulation scheme on a station by station basis as the position of a station changes with respect to said transmission point.

14. The method of claim 1 further comprising changing said modulation scheme on a station by station basis as the passloss of said station changes.

15. A mobile communication system comprising:
a central transmission point;
means for communicating between said transmission point and a plurality of separate communicating devices, each said communication being on a separate communication channel between said transmission point and one of said devices, each said communication channel using a modulation scheme dependant upon interference factors at the location of said mobile device; and
means for determining a particular modulation scheme for each said communication connection between said transmission point and a particular mobile device.

16. The mobile communication system of claim 15 wherein said interference is determined as a function of distance between said transmission point and a particular communicating device, said system further comprising:
means for determining for any said communicating device said distance between said transmission point and said communicating device.

17. The mobile communication system of claim 16 wherein said determining means is located at a central point external to said communicating device.

18. The mobile communication system of claim 17 wherein said determining means comprises:
means for determining distance based, at least in part, on information contained in a signal transmitted to said transmission point from said device.

19. The mobile communication system of claim 16 wherein said determining means is located at least partially within said communicating device.

20. The mobile communication system of claim 19 wherein said determining means comprises GPS.

21. The mobile communication system of claim 15 wherein said interference is determined as a function of power level at a particular communicating device, said system further comprising:
means for determining for any said communicating device a power level of said communicating device.

22. The mobile communication system of claim 21 wherein said power level is determined from information sent to a central point external of said device.

23. The mobile communication system of claim 21 wherein said power level is determined at least in part within said device.

24. The mobile communication system of claim 15 wherein said interference is determined as a function of the passloss of each said communicating device;
means for determining said power requirement on a station by station basis; and
means for determining said passloss on a station by station basis.

25. A device for use in a communication system; said device comprising:
at least two modulation schemes for processing communications via an air interface between said device as a communication transmission point; and
control for, at least in part, determining from time to time, which one of said transmission schemes is to be used for air interface communications between said transmission point and said device.

26. The device of claim 25 wherein said control comprises:
means for determining an interference level of communications at said device.

27. The device of claim 25 wherein said control comprises:
means for determining a location of said device.

28. The device of claim 25 wherein said control comprises:
means for determining the distance of said device from said transmission point.

29. The device of claim 25 wherein said control means comprises:
means for changing said modulation scheme during a particular communication session.
